(19) United States
(12) Patent Application Publication
(10) Pub. No.: US 2003/0085916 A1
(43) Pub. Date: May 8, 2003

(54) Method, apparatus and computer program product for interactive instruction using electronic display device

(76) Inventors: Katherine Thiry, Redmond, WA (US); Denise Slocombe, Marysville, WA (US); Kathy Oneha, Redmond, WA (US)

Correspondence Address: Charles J. Rupnick, PO Box 46752, Seattle, WA, 98146, US

(21) Appl. No.: 10/145,985

(22) Filed: May 15, 2002

Related U.S. Application Data
(60) Provisional application No. 60/350,178, filed on Nov. 2, 2001.

(51) Int. Cl. G09G 5/00

(52) U.S. Cl. 345/738

(57) ABSTRACT

A web-based learning tool having a means for organizing a plurality of interrelated contents, a means for coupling a different one of the interrelated contents to each different one of a plurality of asynchronously operable modular frames as a function of a user input, and a means for concurrently displaying one of the plurality of interrelated contents on each of the modular frames.

This application claims the benefit of U.S. Provisional Application Serial No. 60/350,178, filed in the names of Razvan Neagu, Katherine Thiry, Denise Slocum (properly spelled Slocombe) and Kathy Oneha on Nov. 2, 2001, the complete disclosure of which is incorporated herein by reference.

### FIELD OF THE INVENTION

The present invention relates generally to interactive instruction using media devices and more specifically to interactive athletic instruction and performance analysis using computing devices capable of displaying text and/or graphics.

### BACKGROUND OF THE INVENTION

To learn a sport or other athletic skill, the student athlete typically enrolls in a class or joins a sports-oriented club or organization. Some examples of such classes and organizations include Little League, varsity athletic programs, fencing clubs, and swim instruction offered at a community pool. Typically, during class time or organized training sessions, a coach or instructor guides the athlete in the development of the skill set necessary for participation in the chosen sport. An athlete may additionally develop skills through observation of other athletes at practice, tournaments and/or televised sporting events. The athlete's knowledge and skill advancement in the sport is therefore only partially determined by the athlete's own natural abilities. The athlete's overall achievement is also dependent upon the sport specific knowledge of the coach, the coach's ability to impart that knowledge, and the athlete's own exposure to athletes of advanced skill within that sport. Thus, although two athletes may have the same natural talent and ability, the developmental coach and the experiences available to each athlete are determinant of the performance capabilities each will achieve.

To advance their level of knowledge within a sport and to access larger forums in which their progress and performance can be evaluated, athletes, coaches and organizations typically join larger national or international associations. These larger entities research, collect, maintain and disseminate a body of knowledge on the sport with the aim of maximizing athlete development, standardizing competitive rules and evaluation criteria and advancing the overall strength and quality of the sport. The United States Olympic Committee (USOC) and its member National Governing Bodies for each of the various sports are examples of such larger entities. The USOC invests in science facilities such as the Olympic training centers, in sponsored research; and expends countless man-hours in training seminars, clinics and retreats, all towards the aim of defining and advancing an effective model for training and winning.

Many of the local clubs and organizations offering such athletic training, however, are volunteer organizations or other not for profit entities. As such, the opportunity to capitalize on the resources available for advance training of athletes and coaches is limited. Organizations must frequently hold fundraisers to acquire the needed training materials or to finance visits by more experienced instructors. Dedicated coaches and athletes often acquire the training materials and travel to training seminars or competitions at significant personal expense. For the individual athlete, these constraints erect significant barriers to the attainment of technical acumen and curtail athletic development. In the aggregate, these constraints operate to hinder advancement of the entire sport by limiting the development of the entire body of athletes and from the potential failure to identify and properly train truly elite athletes within the sport. The sport as a whole additionally suffers since the supporting infrastructure of, for example, physicians and officials also encounters significant obstacles to training and information.

The advent of modem media devices has provided sports participants with various additional forms of learning. Video tapes and DVDs are one common learning tool in which the student typically watches another individual demonstrate a particular skill while an expert commentator provides narration. This learning medium has certain inherent limitations. First, the learning experience is passive. Second, the demonstration is often shot from a single angle and cannot be rotated or enlarged for greater scrutiny by the student. Third, the tool is not portable and cannot accompany the student to practice or to sporting events. The video is also only current on the date made and cannot be readily updated.

The internet comprises another medium which makes information on a variety of topics readily available. Most of the web based content currently available fails to provide much functionality beyond the video tape medium. FIG. 1 depicts a web based learning tool of the type currently in use. As shown in FIG. 1, a web page 2 contains a banner heading 4, a video window 6, a text window 8 and an image window 10. Video window 6 consists of a video taped presentation. Text window 8 consists of a time hash or other table of content data that marks the present scene or topic presented in video window 6, while image window 10 typically contains a power point presentation slide or other image actually referenced by the video presenter during the presentation. The content of each of windows 6, 8 and 10 are not independent of each other. When the student clicks on a table of contents entry in window 8, the video presentation displayed

in window 6 and the image shown in window 10 each advance synchronously to correspond with the appropriate point in the video. Thus, the current web based learning experience is simply a repackaging of the older video tape technology and contains many of its limitations.

Other widely used web based formats present the information in a web page format. The web page commonly spans several screens of information through which the user must scroll. Many users find the need to scroll through the material in this manner to be arduous and often abandon or lose interest in locating the material relevant to them. To combat this limitation, hyperlinks to other pages or portions of the page are often provided to rapidly reposition the user on the page or site. However, the hyperlinking process can detract from the users' ability to understand the particular information viewed in the context of the larger site.

The web based learning medium also presents additional frustrations to the learning experience. In particular, the large multimedia downloads leave the user idle and bored. Often, when the student does not have a compelling reason to wait for the download, they give up on the site altogether and move on. Furthermore, web sites frequently exist to advance the business interests of the individual site owner and may include advertising or content that detracts from the learning experience. Even in those situations where a not for profit sports organization hosts and maintains the informational web site, advertising may be included to underwrite the costs of producing the site and running the organization. Advertising usually appears in the form of banner or pop up ads that bear little or no relation to the site content. This advertising occurs in a manner visually disparate from the remainder of the site and viewers typically find it irritating. Not only is the advertising disruptive to the learning experience, the advertisements are not even effective. Research has shown that after some web surfing experience, viewers completely ignore advertisements placed in web pages.

### SUMMARY OF THE INVENTION

The present invention recognizes the problems inherent in the prior art. The present invention provides an interactive tool for athletic instruction and performance analysis.

According to one aspect of the present invention, the invention includes a web based browser format having a plurality of content windows wherein each window includes a browser. The present invention therefore enables separate content to be displayed asynchronously in each of the various windows. Content in one window is not rigidly coupled with content in accompanying windows as in the prior art. Thus, for example, the student may view a video of a platform dive in one window, with a text presentation on the scoring rules for the dive in a second window, and a list of diving competitions in a third window. The viewer may, for example, change the content of the second window to a description of how to perform the dive, without changing the content of the remaining windows.

According to another aspect of the present invention, the user is able to asynchronously select content in the various windows using a multi-cued informational menu. This ability to asynchronously select the content in the various windows, empowers the student to select the content according to that students learning style preferences.

According to another aspect of the present invention, the separate content presented in each of the various windows may be automatically selected according to a theme or other methodology. The present invention therefore enables the user and/or content provider to select or manage the content presented in each window to provide an integrated educational experience rather than the mere disassociated presentation of multiple screens of information.

According to yet another aspect of the present invention, the ability to manage the separate content presented in at least one window, enables advertising content to be managed according to a predefined logic. For example, in a preferred embodiment of the invention, a user who is viewing an athlete profile data, may be shown advertising information describing the equipment provided by the athlete's sponsor. The advertising presented according to the present invention can thus be made relevant to the content viewed by the user, and is therefore also less intrusive and disruptive to the user experience. The presentation of advertising according to the present invention thus also increases the effectiveness of the advertising. The advertising can thus be made a more effective tool in generating income for the local sports organizations.

According to still another aspect of the present invention, various ones of the content windows of the present invention may be ported to multiple platforms. Thus, the present invention enables the user to view the material on a home computer, or, for example, on a personal computing device, or other electronic device having a graphical and/or textual display. The user may therefore access the educational experience provided by the present invention in a variety of settings such as during practice or at a tournament thereby further enhancing the educational benefits of the present invention.

Additional features and advantages of the present invention will be readily apparent from the detailed description of the invention included below made with reference to the drawings.

### BRIEF DESCRIPTION OF THE DRAWINGS

FIG. 1 is a depiction of a web page learning tool according to the prior art;

FIG. 2 is a conceptual block diagram of a learning tool constructed according to a preferred embodiment of the present invention;

FIG. 3 illustrates the operation of an advertising frame according to a preferred embodiment of the present invention;

FIG. 4 illustrates use of dynamic selection of framework content using a menu bar according to a preferred embodiment of the present invention;

FIG. 5 illustrates portability of the framework content to another device according to a preferred embodiment of the present invention;

FIG. 6 illustrates downloading of the framework of the present invention to a personal computing device via the internet according to a preferred embodiment of the present invention;

FIG. 7 illustrates deployment of the framework of the present invention to a CD/DVD medium according to a preferred embodiment of the present invention;

FIG. 8 illustrates deployment of the framework of the present invention to a game console platform according to a preferred embodiment of the present invention; and

FIG. 9 illustrates deployment of the framework of the present invention in a broadcast medium environment according to a preferred embodiment of the present invention.

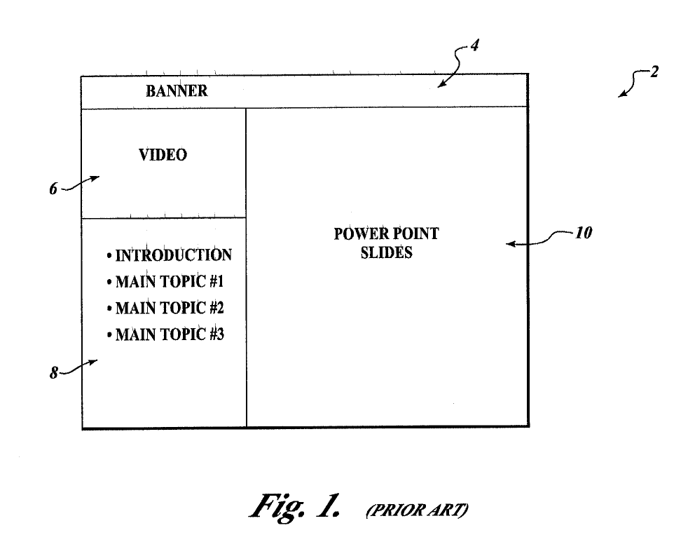

### DETAILED DESCRIPTION OF THE PREFERRED EMBODIMENTS

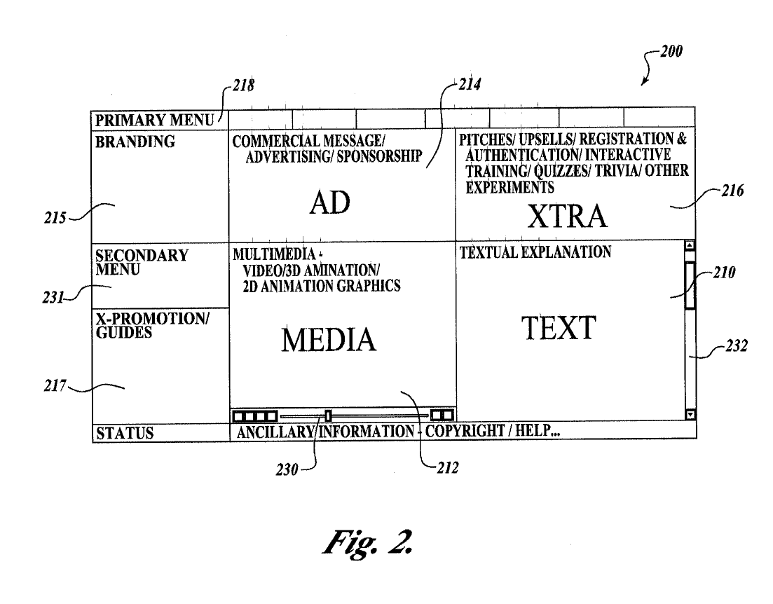

FIG. 2 depicts a conceptual block diagram of a learning tool constructed according to a preferred embodiment of the present invention. The embodiment of FIG. 2 comprises a framework 200 that includes a plurality of frames 210-216 wherein each of frames 210-216 includes separate content. In a preferred embodiment of the invention, framework 200 comprises a browser to be described in greater detail below. The browser integrates the functionality and content of multiple frames 210-216 into a modular but cohesive presentation with unified navigation. The present invention thus differs from and improves upon the web page methodology of the prior art. Although hyperlinking, thumbnails, and scrolling can be enabled within each of the individual frames 210-216, the user of the present invention need not scroll through or hyperlink to related material and may readily discern the relationship between each of the frames contained within framework 200.

Frame Content Overview

According to one possible embodiment of the present invention, frames 210-216 include a text frame 210, a media frame 212, an advertisement frame 214 and an extra content frame 216. Other distributions of frame content are possible, however, and the invention is not limited to the particular frame contents shown in FIG. 2.

A banner frame 215, or region, may be displayed within framework 200. Banner frame 215 may be used, for example, to identify the sponsor or author of the content currently displayed on framework 200. Different individual banners may be displayed according to the specific content currently being viewed. In this way, the user can gauge the authenticity or reliability of the information presented. Optionally, banner frame 215 may be used to identify a sponsor of a particular framework 200 or particular topic within framework 200.

Cross promotional guide region 217 may also be included within framework 200. Cross promotional guide region 217 may be used to display promotional materials related to a particular organization or club sponsor, or may optionally contain links to such material. Cross promotional guide region 217 may also be used to display a calendar or schedule of events relevant to the particular subject matter displayed in framework 200.

Media frame 212 is useful for displaying multimedia content to the user. Media frame 212 enhances the educational experience of the user by illustrating concepts in an active and compelling manner. In a preferred embodiment of the invention, media frame 212 accommodates standard size media measuring 320 pixels wide by 240 pixels high. Other pixel dimensions and formats known to those of skill in the art may also be used with the present invention. The multimedia content presented using frame 212 may include, for example: streaming media of e.g. live telecast sporting events, or other broadcast information, video library clips of skills demonstrations or athlete performances, interactive games, or graphical animation of proper techniques. According to one possible embodiment of the invention, when animated graphics are provided, the user may optionally rotate the presentation using tool bar 218 or using a tool bar presented within frame 212. Rotating the frame enables the user to view the demonstrated techniques from different angles. Media frame 212 may also optionally include a scroll bar 230 that enables the user to advance to or review a desired portion of the media content.

Text frame 210 includes text data related to the subject matter selected by the user from navigation toolbar(s) 218, 231. Examples of the types of content that may be presented in text frame 210 include: rules for judging or scoring; performance analysis and skills descriptions; and athlete profiles. Because the text data files presented in frame 210 are small relative to the media or other graphical content presented in media frame 212, a preferred embodiment of the present invention loads the text information presented in frame 210 prior to loading the content presented in the remaining frames. This hierarchy enables the user to interact with the educational content of text frame 210 while waiting for larger media files to load thereby retaining the user's attention during the download process. Text frame 210 may also include a scroll bar 232 that enables the user to advance to other portions of the content presented in frame 210.

The embodiment of FIG. 2 additionally includes extra content frame 216. Extra content frame 216 may be used to provide any type of additional content such as text, graphics or advertising or other content. The particular contents of frame 216 may be selected from the menu as chosen by the user or according to stored tables or logic that direct display of certain information in window 216 according to the content displayed in another of the windows. Optionally, thumbnails or hyperlinks contained in the remaining windows may, when activated, cause the associated content to be loaded into the extra content frame 216.

Advertising frame 214 of the present invention provides a unique way of presenting advertising content without the inherent limitations of the banner ads used in the prior art. As to be discussed in greater detail below, the content and control of the appearance of frame 214 on framework 200 may be dynamically coupled to the content selected by and/or the status of the user. This coupling results in an advertising experience that is relevant and personalized to the user and integrated with the remaining content of framework 200. The effectiveness of the advertising presentation is thereby improved.

In a preferred embodiment of the invention, advertisement frame 214 provides a larger screen real estate than that used by standard banner ads but is preferably dimensioned in such a way as to still accommodate standard size ads. According to one possible embodiment, frame 214 fits two long standard banner ads placed on top of each other. This larger size provides for more authoring flexibility while retaining the ability to display advertisements from a banner ad pool. Advertising content may also include multimedia content such as streaming video.

The structure of the present invention also enables frames to be fused together such that advertising frame 214 can increase in size by taking over the screen real estate of another of frames 210-212 or preferably extra content frame 216. In one possible embodiment, the increase in size can occur dynamically when the user clicks on frame 214. The user gets more information in the increased size format without leaving the content and context provided by the remaining frames.

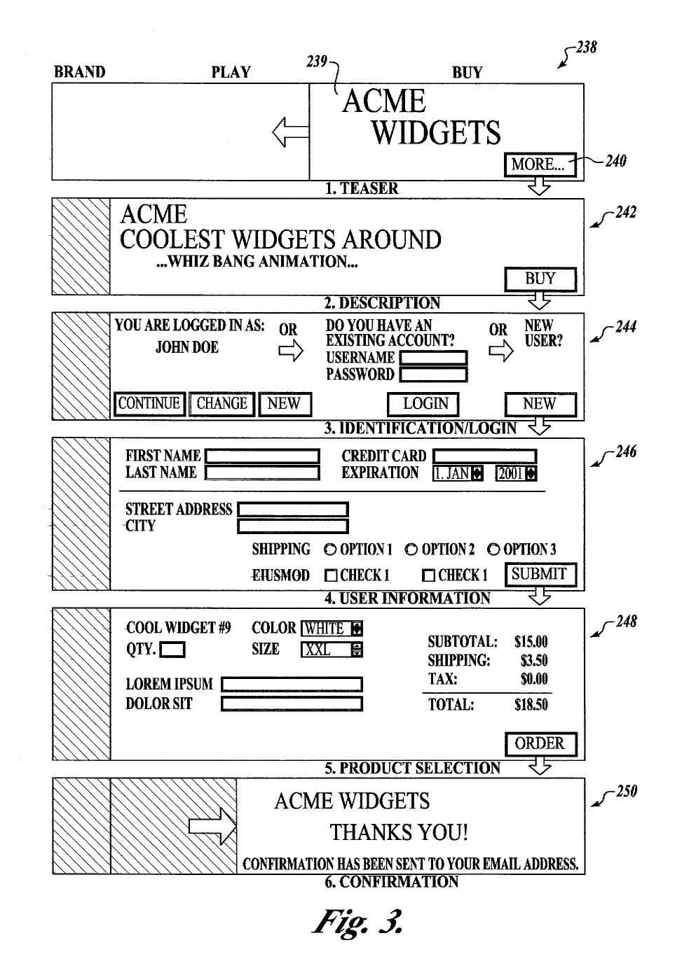

FIG. 3 depicts an example of how advertising frame 214 might be used to provide the advertiser a chance to actually sell a product in place. FIG. 3 shows advertising frame 214 on the right expanding to take the space allotted for extra content frame 216 on the left. In step 238 of FIG. 3, an advertisement 239 appears in frame 214 of framework 200. The user reviews the advertisement content and clicks on button 240 to request additional information. In response, additional advertising content is provided by the content provider and frame 214 expands to include the viewing area previously occupied by extra content frame 216 as shown in step 242. Steps 244-248 illustrate how the user may interact with advertising frame 214 to purchase goods or services. Other sales transaction methodologies known to those of skill in the art may also be used. In step 250 upon conclusion of the transaction or a return by the user to other frames, advertising frame 214 returns to its original size.

Operation and Implementation

As shown in FIG. 2, the architecture of the present invention comprises a browser structure wherein each of the modular frames comprises a separate browser. This architecture permits each of frames 210-216 to have its own HTML, or other markup language programming. Because each of the frames contained within framework 200 includes its own programming, each of the frames can operate or otherwise be operated asynchronously from the remaining frames. Changing the content in one of the frames does not necessarily cause a change to occur in the remaining frames.

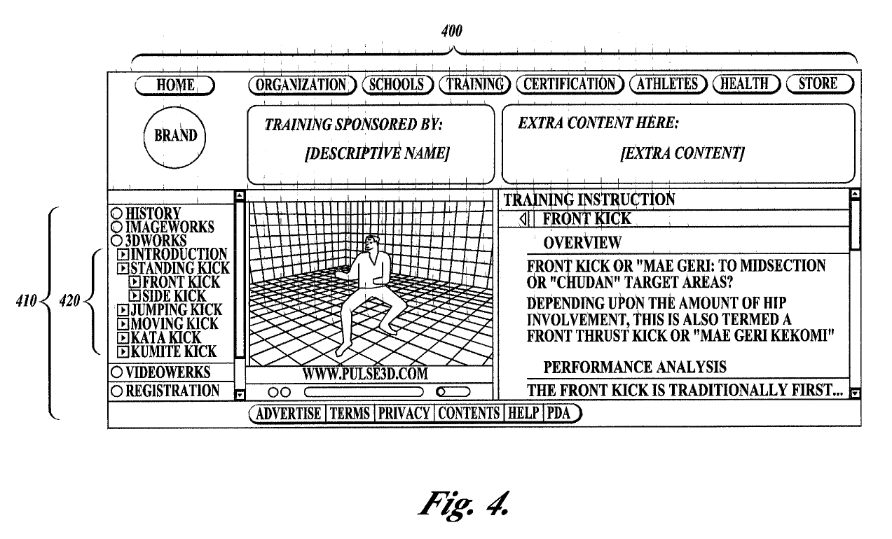

FIG. 4 illustrates how the content in each of the frames may be selected by the user and also how framework 200 may be constructed to relate the content of the individual frames by a common theme. In the illustrative embodiment of FIG. 4, framework 200 includes a primary navigation bar 400. When the user clicks on one of the topics identified in navigation bar 400, a secondary navigation menu 410 associated with the topic selected appears. Optionally, a tertiary navigation menu 420 may appear in response to the user clicking on a secondary navigation menu topic. In response to the selection of a topic by the user, programming contained within framework 200 loads content into each of the frames. The individual frame content can be loaded according to any one of the various navigation menus. Optionally, the content to be loaded in all frames may be loaded according to the lowest level menu selected.

Enabling the user to select the content of the individual frames presented on the screen empowers the user with the ability to configure a learning tool compatible with the individual learning style of that particular user. For example, an older user when viewing a media presentation of a karate front kick may prefer a textual description of how to perform the kick. A younger user may prefer that interactive game or quiz be displayed in the text window, while the competition athlete or referee candidate may select display of the rules for scoring the kick. This capability improves the assimilation and retention of the material by the user as well as enhancing the enjoyment of the user experience.

The content associated with the user topic selection may be contained, for example, in a look up table. In a preferred embodiment of the invention, the content interrelationship between the frames is provided by pointers within the DreamWeaver tool used to create the individual frames. Optionally, thumbnails and hyperlinks, as known to those of skill in the art, may be included within the content loaded in an individual frame. Clicking on the thumbnail or hyperlink causes the content contained within one of the remaining windows to change.

The correlation of graphic and textual information in framework 200 organized by user menu selection or by logical theme, assists the user in the assimilation and retention of the information presented. Thus, the present invention provides an integrated learning experience rather than the mere presentation of information. This advantage of the present invention is reinforced by associating interactive features such as games, and other interactive materials with the specific content displayed in the various windows, or the user's particular menu selections.

Portability

According to a preferred embodiment of the invention, having each of the frames comprising framework 200 comprised of separate HTML code enables individual ones of the frames to be downloaded or ported to another device. Various portable devices, such as, for example, cellular telephones, personal data assistants (PDAs), portable computers, tablet computers provide users with the ability to access or transport data remotely. This capability provides the student athlete, or any student, with the capability to transport the information provided by the present invention to the location or forum desired by the user. For example, the student referee might download the text screen describing scoring rules to a PDA for viewing at a referee clinic. The sports enthusiast might chose to download individual athlete profiles for viewing during a tournament. Many more examples of portability are possible and the invention is not limited to the few examples described above.

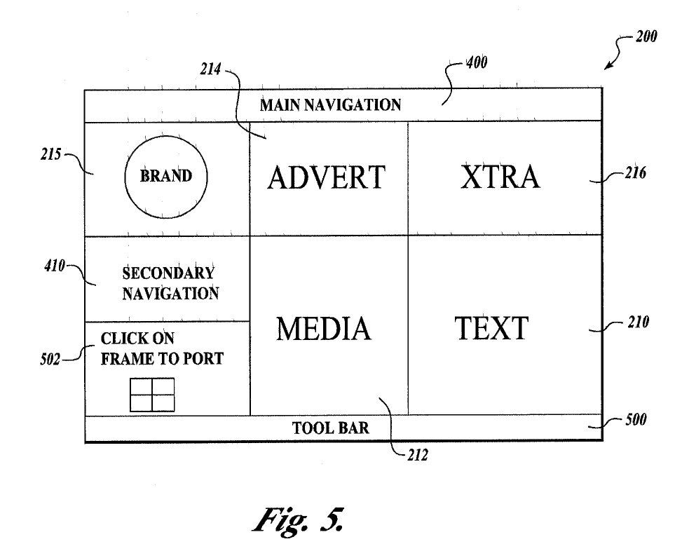

To port a frame to another device, the user clicks on tool bar 500 as shown in FIG. 5. A menu 502 then appears as shown from which the user can select the frame to be ported. Many possible methods for presenting this menu can be used, such as a list with radio buttons, highlighted text and the invention is not limited to the format shown in FIG. 5. The format and screen size of the target device are preferably read from a registry storing such information. The registry may be stored on the host device or optionally read from a registry stored on the target device.

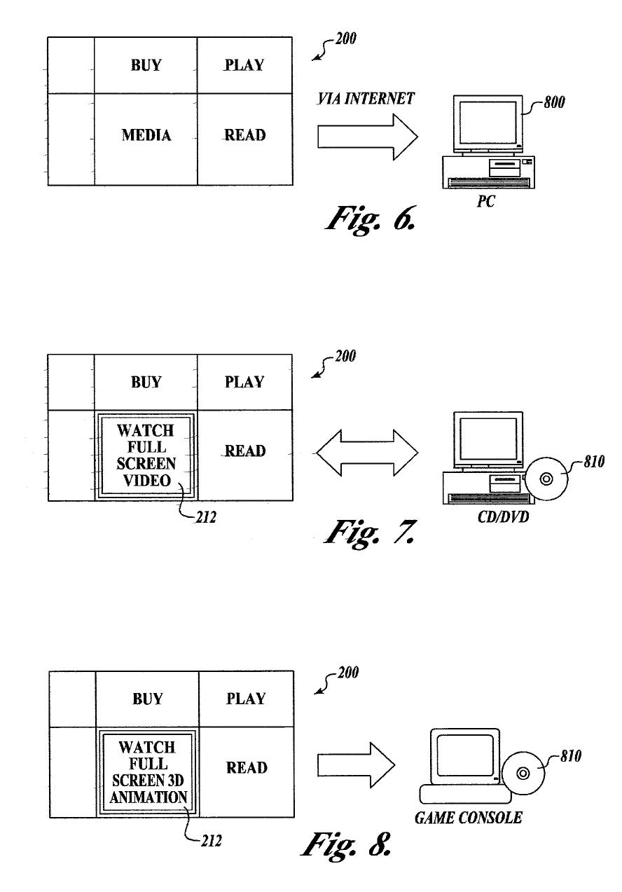

In addition to providing apparatus and methods, the present invention also provides a computer program product for asynchronously displaying interrelated information. FIG. 6 for example illustrates downloading of the framework 200 of the present invention to a personal computing device 800 via the internet according to a preferred embodiment of the present invention.

FIG. 7 illustrates deployment of the framework 200 of the present invention to a CD/DVD medium 810 according to a preferred embodiment of the present invention. Alternatively, the framework 200 of the present invention is deployed to another computer-readable portable medium, such as a floppy diskette or another suitable medium that is currently known or unknown. In FIG. 7, the computer program product includes the computer readable storage medium 810 having the framework 200 of the present invention, or a portion thereof, deployed thereon as computer readable program code means embodied in the medium. The processor portion of the personal computing device 800 implements the computer readable program code means to asynchronously display interrelated information in textual and graphical formats.

The computer-readable program code means includes first computer-readable program code means for organizing a plurality of interrelated information in a computer readable format.

Further, the computer-readable program code means also includes second computer-readable program code means for coupling a different portion of the interrelated computer readable information organized by the first computer-readable program code means to different ones of a plurality of asynchronously operable modular frames as a function of a user input.

Third computer-readable program code means are included for concurrently displaying on each of the modular frames one of the plurality of information organized by the first computer-readable program code means and coupled to different ones of a plurality of asynchronously operable modular frames by the second computer-readable program code means.

Fourth computer-readable program code means may be included for structuring loading of the plurality of interrelated information according to a hierarchy having text content loaded prior to media content.

With reference to the third computer-readable program code means, as discussed previously with respect to the various apparatus and methods of the present invention, the third computer-readable program code means for concurrently displaying one of the plurality of information also includes means for displaying the information in textual and graphical format. Furthermore, the third computer-readable program code means for displaying information in a graphical format may include means for displaying a presentation of graphical animation from a plurality of different points of view.

The third computer-readable program code means for displaying information may also include means for fusing two or more frames into a single frame for displaying a plurality of interrelated advertising information. According to one embodiment of the invention, the computer-readable program code means for fusing two or more frames into a single frame also includes means for displaying advertising information in an advertising frame; expanding the advertising frame into a different one of the plurality of frames in response to user input; and in response to additional user input, returning to a previous display condition.

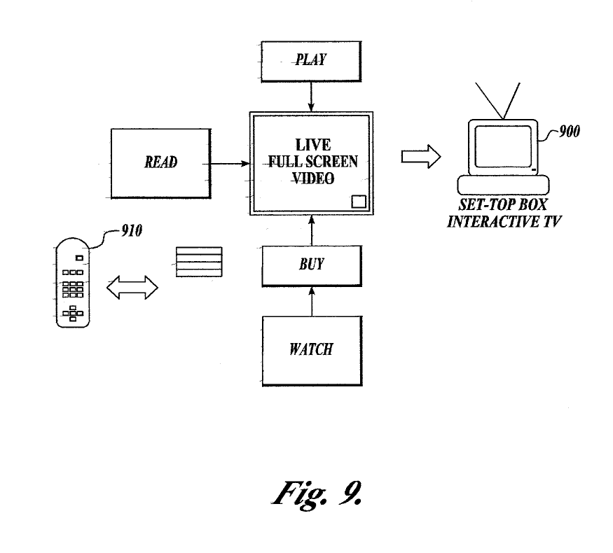

FIG. 8 illustrates deployment of the framework 200 of the present invention to a game console platform 820 according to a preferred embodiment of the present invention.

FIG. 9 illustrates deployment of the framework 200 of the present invention in a broadcast medium environment according to a preferred embodiment of the present invention, wherein the framework 200 of the present invention is downloaded to a set-top box interactive television platform 900 in which the user interacts via a remote control mechanism 910.

While the preferred embodiment of the invention has been illustrated and described, it will be appreciated that various changes can be made therein without departing from the spirit and scope of the invention.

What is claimed is:

1. A browser comprising:
a plurality of modular frames each comprising a separate browser that is structured to operate asynchronously from others of the plurality of modular frames; and
one of a plurality of related content concurrently displayable on each of the plurality of modular frames as a function of a user input; and
a navigation menu coupled to accept the user input and being coupled to each of the plurality of modular frames and each of a plurality of the contents for display of a different one of the contents on each of the modular frames.

2. The browser of claim 1 wherein the plurality of related content includes one or more of textual, graphical, and interactive content.

3. The browser of claim 1 wherein the contents concurrently displayable on each of the plurality of modular frames are organized as a function of one of a user selection and a logical theme.

4. The browser of claim 1 wherein the contents concurrently displayable on each of the plurality of modular frames are organized as a function of pointers within a software tool used to create the frames.

5. The browser of claim 1 wherein the one of the concurrently displayable plurality of related content further includes content stored in a look-up table.

6. A web-based learning tool comprising:
means for organizing a plurality of interrelated contents;
means for coupling a different one of the interrelated contents to each different one of a plurality of asynchronously operable modular frames as a function of a user input; and
means for concurrently displaying one of the plurality of interrelated contents on each of the modular frames.

7. The learning tool of claim 6 wherein the displaying means further comprises means for displaying text content, multimedia content, advertisement content, and extra content.

8. The learning tool of claim 7 wherein the means for displaying multimedia content further comprises means for displaying a presentation of graphical animation from a plurality of points of view.

9. The learning tool of claim 6 wherein the organizing means further comprises means for organizing as a function of one of a user menu and a logical theme.

10. The learning tool of claim 6, further comprising means for structuring a hierarchy of content loading having text content loaded prior to media content.

11. The learning tool of claim 6, further comprising means for fusing two or more frames into a single frame for displaying a single content.

12. A web-based learning tool comprising:
a plurality of different content interrelated according to a common theme;
a plurality of frames organized in a web-based browser format, each of the frames comprising a separate browser and being structured to operate programming code independent of each other frame; and
a navigation tool bar coupled to the content and to the frames for asynchronously selecting which of the plurality of different interrelated content is displayed in each of the plurality of frames.

13. The learning tool of claim 12 wherein each of the plurality of different interrelated content further comprises one of a textual, graphical, and interactive content.

14. The learning tool of claim 12 wherein the plurality of different interrelated content is further organized as a function of user input.

15. The learning tool of claim 12 wherein the plurality of different interrelated content is further organized as a function of a logical theme.

16. A method for asynchronously displaying interrelated information, the method comprising:
organizing a plurality of interrelated information in a computer readable format;
coupling a different portion of the interrelated computer readable information to different ones of a plurality of asynchronously operable modular frames as a function of a user input; and
concurrently displaying one of the plurality of information on each of the modular frames.

17. The method of claim 16 wherein displaying information further comprises displaying a presentation of graphical animation from a plurality of different points of view.

18. The method of claim 16, further comprising structuring loading of the information according to a hierarchy having text content loaded prior to media content.

19. The method of claim 16, further comprising fusing two or more frames into a single frame for displaying a plurality of interrelated advertising information.

20. The method of claim 19 wherein displaying a plurality of interrelated advertising information in a single frame further comprises:
i) displaying advertising information in an advertising frame;
ii) in response to user input, expanding the advertising frame into a different one of the plurality of frames; and
iii) in response to additional user input, returning to a previous display condition.

21. A computer program product for asynchronously displaying interrelated information in textual and graphical formats, wherein the computer program product comprises:
a computer-readable storage medium; and
computer-readable program code means embodied in the medium, the computer-readable program code means comprising:
first computer-readable program code means for organizing a plurality of interrelated information in a computer readable format;
second computer-readable program code means for coupling a different portion of the interrelated computer-readable information organized by the first computer-readable program code means to different ones of a plurality of asynchronously operable modular frames as a function of a user input; and
third computer-readable program code means for concurrently displaying on each of the modular frames one of the plurality of interrelated computer-readable information.

22. The computer program product of claim 21, further comprising fourth computer-readable program code means for structuring loading of the plurality of interrelated information according to a hierarchy having text content loaded prior to media content.

23. The computer program product of claim 21 wherein the third computer-readable program code means for concurrently displaying one of the plurality of information further comprises means for displaying the information in a graphical format having graphical animation presented from a plurality of different points of view.
